(19) United States
(12) Patent Application Publication
(10) Pub. No.: US 2023/0137685 A1
(43) Pub. Date: May 4, 2023

(54) FABRIC CARE COMPOSITIONS, METHODS OF USE FOR REDUCING MICROFIBER RELEASE FROM FABRICS, AND ARTICLES EXHIBITING IMPROVED RESISTANCE TO MICROFIBER RELEASE

(71) Applicant: Church & Dwight Co., Inc., Princeton, NJ (US)

(72) Inventors: Rahul Parakhia, Hillsborough, NJ (US); Leilani Pechera, Kendall, NJ (US); Joan Gambogi, Hillsborough, NJ (US); Archana Gupta, Belle Mead, NJ (US); David Treharne, Wall, NJ (US)

(73) Assignee: Church & Dwight Co., Inc., Princeton, NJ (US)

(21) Appl. No.: 17/975,086

(22) Filed: Oct. 27, 2022

Related U.S. Application Data
(60) Provisional application No. 63/272,818, filed on Oct. 28, 2021.

(51) Int. Cl. C11D 3/00; C11D 11/00; C11D 1/83; C11D 3/382; C11D 3/37; C11D 3/22

(52) U.S. Cl. CPC C11D 3/0015; C11D 1/83; C11D 3/225; C11D 3/382; C11D 3/3707; C11D 3/3773; C11D 11/0017; C11D 1/72

(57) ABSTRACT

Presently provided are compositions and method that are effective to prevent or reduce formation and/or release of microplastics, particularly microfibers, from fibers, from fabrics including fibers, and articles incorporating fabrics that include fibers. The fibers particularly can be synthetic fibers. Articles, fabrics, and fibers exhibiting such properties are likewise provided. Such properties particularly can be imparted through use of conditioning and/or softening polymers that can be provided in the present compositions to be contacted with the fibers so that the polymers adhere to or otherwise bind with the fibers. Encompassed compositions include laundry compositions and other compositions suitable for application to fibers and fabrics including such fibers. Encompassed methods can be effective for preventing or reducing release of microfibers to the environment.

### CROSS-REFERENCE TO RELATED APPLICATIONS

The present application claims priority to U.S. Provisional Pat. Application No. 63/272,818, filed Oct. 28, 2021, the disclosure of which is incorporated herein by reference in its entirety.

### FIELD OF THE INVENTION

The present disclosure relates to compositions for use in treating fabrics to impart efficacy for preventing or reducing breakage of fibers, particularly fibers that persist in the environment for a significant duration, such as synthetic fibers. The disclosure likewise relates to fabrics treated with the compositions, articles incorporating the treated fabrics, and methods for preventing or reducing release of microfibers to the environment.

### BACKGROUND

There are increasing concerns on the pollution of microplastics (<5 mm) in the environment, including but not limited to introduction of microplastics into oceans. The accumulation of synthetic particles (or other, persisting particles) in the environment has detrimental effects on a variety of different ecosystems through direct effects on biology and indirectly by acting as carriers for other environmental toxicants. Detrimental effects have been particularly identified in relation to marine ecosystems where microplastics are known to make their way rapidly into the food chain, including ultimately entering the human food chain through marine sources.

Reports have indicated that clothing items and other fabrics including synthetic fibers are a significant source of these microplastics, particularly microplastic fibers or microfibers (e.g. 5 mm to 1 µm). The use of synthetic fibers in fabrics and garments (e.g., fabrics including polyester fibers and the like) continues to grow at a rapid pace, and microfibers from such items are released during laundering, including domestic laundering, in a surprisingly large concentration. Released microfibers are of a size such that they predominately pass through typical filter systems in laundry machines and municipal water treatment facilities, and the microfibers ultimately enter the waterways through effluent from such facilities.

Because of the prevalence and increasing production of synthetic fabrics, and because synthetic fibers are prone to breakage that forms microfibers that are released to the environment, particularly through laundering, there remain unique challenges in preventing or reducing formation and/or release of synthetic fibers from such fabrics. Accordingly, there remains a need in the art for compositions that can be used to treat synthetic fabrics in a variety of manners that can prevent and/or reduce formation and/or release of microfibers from fabrics that synthetic fibers and thus reduce adverse environmental impacts from microplastics, and particularly microfibers.

### SUMMARY OF THE DISCLOSURE

The present disclosure provides a composition that can be useful for preventing or reducing microfiber release in fabric. The composition can be provided to not only smooth an article fabric surface for an initial softer feel but to additionally make the fabrics of the article more environmentally safe through addition of conditioning/softening polymers. Articles treated with the disclosed compositions are provided in the present disclosure exhibiting improved resistance to release of microfibers. A method of preventing or reducing release of microfibers by application to the fabric are also provided along with a method for imparting improved resistance to formation of microfibers to a fabric are presently disclosed.

In some embodiments, a laundry composition for preventing or reducing release of microfibers, according to the present disclosure can comprise: one or more anionic or nonionic surfactants; and a polymer that is effective as one or both of a softening agent or a conditioning agent for a fabric comprising fibers (and particularly synthetic fibers), wherein the polymer is configured to adhere to at least a portion of the fibers of the fabric when the fabric and the laundry composition are both present in a washing medium, and wherein the polymer, when adhered to the fibers, is effective to prevent or reduce formation of microfibers due to breakage of the fibers and thus prevent or reduce release of the microfibers into the washing medium. In further embodiments, the laundry composition can be defined in relation to one or more of the following statements, which can be combined in any number or order.

The laundry composition can have a total amount of up to about 70% by weight of the one or more anionic or nonionic surfactants based on a total weight of the laundry composition.

The laundry composition can have up to about 5% by weight of the polymer relative to a total weight of the laundry composition.

The polymer can be compatible with all further components of the laundry composition such that the laundry composition as finally formulated is stable such that one or more measurable properties of the laundry composition as originally formulated remains substantially unchanged during storage of the laundry composition. Such measurable properties can include, as non-limiting examples, clarity (particularly of a liquid form), color, pH, viscosity (particularly of a liquid form or semi-solid form, such as a gel), homogeneity, and the like.

The laundry composition can be effective to prevent or reduce formation of microfibers such that a total mass of microfibers released into the washing medium from the fabric comprising the fibers during washing with the laundry composition comprising the polymer is at least 20% less than a total mass of microfibers released into the washing medium from the fabric comprising the fibers during washing with the laundry composition without the polymer.

The polymer, when adhered to the fibers, can be effective to prevent or reduce formation of microfibers due to breakage of the fibers arising from frictional forces on the fabric during washing of the fabric.

The polymer can be a silicone modified protein.

The polymer can be a pegylated ammonium chloride.

The polymer can be a cellulose ether polymer.

The polymer can be a copolymer of an acrylamide and an allylic ammonium chloride.

The polymer can be configured to sufficiently adhere to the at least a portion of the fibers of the fabric so that an amount of the polymer remains adhered to the at least a portion of the fibers after removal from the washing medium.

The polymer can be configured to selectively adhere to one or more of polyamide fibers, polyester fibers, polyether-polyurea fibers, and acrylonitrile fibers.

The laundry composition further can comprise a component selected from the group consisting of chelators, builders, alkalinizing agents, viscosifiers, bicarbonates, enzymes, enzyme stabilizers, dyes, optical brighteners, antiredeposition polymers, fluorescent whitening agents, fragrances, bittering agents, antifoaming agents, pH adjustors, bleaches, pearl luster agents, preservatives, laundry boosters, and combinations thereof.

The laundry composition can comprise about 30% by weight or more of an aqueous base, relative to a total weight of the laundry composition.

In some embodiments, a method for preventing or reducing release of microfibers to the environment, according to the present disclosure can comprise: washing a fabric that comprises fibers (and particularly synthetic fibers) so that prior to or during the washing, the fabric is contacted with a composition that comprises a polymer that is effective as one or both of a softening agent or a conditioning agent for the fabric comprising the fibers, wherein the polymer is configured to adhere to at least a portion of the fibers of the fabric, and wherein the polymer, when adhered to the fibers, is effective to prevent or reduce formation of microfibers due to breakage of the fibers and thus prevent or reduce release of the microfibers to the environment through effluent from the washing. In further embodiments, the method for preventing or reducing release of microfibers to the environment can be defined in relation to one or more of the following statements, which can be combined in any number or order.

The composition comprising the polymer can be a laundry detergent, and the method can include washing the fabric with the laundry detergent.

The composition comprising the polymer can be a pre-treatment, and the method comprises applying the pre-treatment to the fabric prior to washing the fabric.

The pre-treatment can be configured as a spray, an aerosol, a foam, or a roll-on.

The total mass of microfibers released from the fabric comprising the fibers during the washing with the polymer adhered to the fibers can be at least 20% less than a total mass of microfibers released from the fabric comprising the fibers during washing without the polymer adhered to the fibers.

The polymer, when adhered to at least the fibers, can be effective to prevent or reduce formation of microfibers due to breakage of the fibers arising from frictional forces on the fabric during the washing.

The polymer can be selected from the group consisting of a silicone modified protein, a pegylated ammonium chloride, a cellulose ether polymer, a copolymer of an acrylamide and an allylic ammonium chloride, and combinations thereof.

The polymer can be configured to sufficiently adhere to the at least a portion of the fibers of the fabric so that an amount of the polymer remains adhered to the at least a portion of the fibers after the washing.

The polymer can be configured to selectively adhere to one or more of polyamide fibers, polyester fibers, polyether-polyurea fibers, and acrylonitrile fibers.

In some embodiments, an article exhibiting improved resistance to release of microfibers according to the present disclosure can comprise: a fabric that comprises fibers (and particularly synthetic fibers); and a polymer that is adhered to at least a portion of the fibers of the fabric, the polymer being effective as one or both of a softening agent or a conditioning agent for the fabric comprising the fibers; wherein the presence of the polymer adhered to at least a portion of the fibers of the fabric is effective to prevent or reduce formation of microfibers due to breakage of the fibers due to application of frictional forces to the fabric. In further embodiments, the article exhibiting improved resistance to release of microfibers can be defined in relation to one or more of the following statements, which can be combined in any number or order.

The polymer can be selected from the group consisting of a silicone modified protein, a pegylated ammonium chloride, a cellulose ether polymer, a copolymer of an acrylamide and an allylic ammonium chloride, and combinations thereof.

The polymer can be configured to sufficiently adhere to the at least a portion of the fibers of the fabric so that an amount of the polymer remains adhered to the at least a portion of the fibers after the article is subjected to a first washing.

The polymer can be configured to selectively adhere to one or more of polyamide fibers, polyester fibers, polyether-polyurea fibers, and acrylonitrile fibers.

The article can exhibit improved resistance to release of microfibers such that a total mass of microfibers released during a washing in an aqueous washing medium from the fabric comprising the fibers with the polymer adhered to the fibers is at least 20% less than a total mass of microfibers released during a washing in an aqueous washing medium from the fabric comprising the fibers without the polymer adhered to the fibers.

In some embodiments, a method for imparting to a fabric improved resistance to formation of microfibers according to the present disclosure can comprise: applying to a fabric comprising fibers (and particularly synthetic fibers) a composition that comprises a liquid medium and a polymer that is effective as one or both of a softening agent or a conditioning agent for the fabric comprising the synthetic fibers, said applying being effective so that the polymer becomes adhered to at least a portion of the fibers of the fabric; wherein the presence of the polymer adhered to at least a portion of the fibers of the fabric is effective to prevent or reduce formation of microfibers due to breakage of the fibers due to application of frictional forces to the fabric. In further embodiments, the method for imparting to a fabric improved resistance to formation of microfibers can be defined in relation to one or more of the following statements, which can be combined in any number or order.

The polymer can be selected from the group consisting of a silicone modified protein, a pegylated ammonium chloride, a cellulose ether polymer, a copolymer of an acrylamide and an allylic ammonium chloride, and combinations thereof.

The polymer can be configured to sufficiently adhere to the at least a portion of the fibers of the fabric so that an amount of the polymer remains adhered to the at least a portion of the fibers after the fabric is subjected to a first washing.

The polymer can be configured to selectively adhere to one or more of polyamide fibers, polyester fibers, polyether-polyurea fibers, and acrylonitrile fibers.

The fabric can exhibit improved resistance to formation of microfibers such that a total mass of microfibers released during a washing in an aqueous washing medium from the fabric comprising the fibers with the polymer adhered to the fibers is at least 20% less than a total mass of microfibers released during a washing in an aqueous washing medium from the fabric comprising the fibers without the polymer adhered to the fibers.

### BRIEF DESCRIPTION OF THE FIGURES

FIG. 1 is a graph showing the average weight of microfibers released into a washing medium during simulated washing of seven different types of fabric samples and illustrating the ability to reduce the amount of microfibers released when washing in the presence of compositions including protective polymers according to embodiments of the present disclosure.

FIG. 2 is a graph showing the average weight of microfibers released into a washing medium during simulated washing of terry cotton swatches and illustrating the ability to reduce the amount of microfibers released when washing in the presence of compositions including protective polymers according to embodiments of the present disclosure.

FIG. 3 is a graph showing the average weight of microfibers released into a washing medium during simulated washing of a fabric comprising 72% rayon, 24% nylon, and 4% spandex and illustrating the ability to reduce the amount of microfibers released when washing in the presence of compositions including protective polymers according to embodiments of the present disclosure.

FIG. 4 is a graph showing the average number of microfibers released into a washing medium during simulated washing of polyester fabric samples and illustrating the ability to reduce the amount of microfibers released when washing in the presence of compositions including protective polymers according to embodiments of the present disclosure.

FIG. 5 is a graph showing the average mass of microparticles that include microfibers filtered from a washing medium during simulated washing of polyester fabric samples and illustrating the ability to reduce the amount of microparticles including microfibers released when washing in the presence of compositions including protective polymers according to embodiments of the present disclosure.

FIG. 6 is an image showing swatches of fabric subjected to washing with a composition according to embodiments of the present disclosure including a polymer component or washing with commercial laundry detergents and dye testing such that darker coloring due to retained dye after washing is indicative of the polymer component being adhered to fibers in the fabric.

FIG. 7 is an image showing swatches of fabric subjected to washing with a composition according to embodiments of the present disclosure including a polymer component or washing with commercial laundry detergents and dye testing such that darker coloring due to retained dye after washing is indicative of the polymer component being adhered to fibers in the fabric

### DETAILED DESCRIPTION OF THE DISCLOSURE

The present disclosure now will be described more fully hereinafter. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure relates to implementations whereby release of microplastics, particularly in the form of microfibers, can be prevented or reduced so as to reduce the environmental impact of such microplastics. As such, the present disclosure encompasses at least the following: compositions that comprise one or more conditioning/softening polymers that are effective to prevent, reduce, or minimize breakage of fibers and/or release of microfibers; methods of using such compositions on fibers, fabrics including fibers, and articles incorporating or made from such fabrics (e.g., clothing articles, bedding, blankets, etc.); and articles that incorporate fibers and have adhered or otherwise bound thereto a polymer that is effective to prevent, reduce, or minimize breakage of the fibers and/or release of microfibers from the fibers.

In some embodiments, the present disclosure relates to compositions that can be applied to fibers and/or fabrics that include fibers in order to impart efficacy for preventing or reducing breakage of the fibers. The compositions can be provided in a variety of forms that allow for application to fibers and/or fabrics under a wide range of conditions and settings. In particular, the compositions can be configured as laundry compositions, such as laundry detergents, pretreatments (e.g., stain removers), fabric softeners (e.g. liquids for use in washing machines), in-wash boosters (e.g. powders, liquids, dual-chamber formulas), and similar compositions that are effective to contact fabrics prior to or during laundering, such as in a washing machine or hand washing. Such compositions can be effective to particularly prevent, reduce, or minimize breakage of fibers in the fabric that may occur prior to laundering, during the laundering process, and/or between launderings. This in turn can prevent, reduce, or minimize release of microfibers into the washing medium during laundering. In particular, components of the laundry compositions can deposit on or adhere to fibers of the fabrics in order to provide the desired effect. Such components of the laundry compositions may provide protection to the fibers during the laundering process and, in some embodiments, residual amounts of such components may be retained by the fabric after the laundering process to provide further protection during wearing and the like. Similarly, the compositions may be configured as a dryer additive. For example, dryer sheets and/or dryer balls that are used in drying machines may include compositions with the polymer so that the polymer is released into the dryer for contact with fibers of fabrics therein to adhere to the fibers and provide protection to the fibers prior to or during a later washing cycle. Spray compositions, dryer pods, and other configurations may also be utilized in order to provide the polymer composition within a dryer to provide protection to the fibers therein. In other embodiments, the compositions may be configured as compositions that are utilized in some treatment of a fabric separate from laundering, such as a refreshing spray, a softening and/or conditioning composition that is applied to a fabric item (e.g., an article of clothing) to provide improved softness or the like, or other, similar composition that may be applied to fabrics for a use other than laundering. Again, components of the compositions can deposit on or adhere to the fibers of the fabrics in order to provide the desired effect so that fiber breakage is prevented, reduced, or minimized prior to laundering and/or during laundering.

The compositions of the present disclosure may be provided in any suitable form, such as liquid, semi-solid (e.g., gels), solid, and other forms. In certain embodiments, the compositions of the present disclosure may be provided in a liquid form for ease of application and/or for ease or manufacturing. Solid forms may be less preferred not only due to increased difficulty in application to the fabric of the composition components that provide the desired effect but also due to possible addition of mechanical forces during laundering processes, such as using a powdered laundry detergent. Powdered laundry detergents effective for rapid dissolution in the washing medium, however, can still be useful by avoiding unnecessary addition of mechanical interactions in a washing process. In some embodiments, solid and/or semi-solid compositions may be expressly excluded. Non-limiting examples of suitable forms of the compositions may include (or exclude) any of the following: bulk liquids; bulk powders, granules, pellets, flakes, or the like; unit dose liquids (e.g., in a dissolvable pack or pouch); unit dose solids (e.g., powders, granules, pellets, flakes, or the like in a dissolvable pack or pouch); solids compressed into a unit dose form, such as tablets; sheets; strips; films; foils; swatches; pretreatment soaks (e.g., liquids, solids, or unit doses configured for dissolution in water for soaking prior to washing); solid treatment sticks; gel sticks; foams; an any other form suitable for addition to a washing machine, addition to a drying machine, use in pre-treatment application or pre-treatment soak, use in hand washing, or use in spot application.

The presently disclosed compositions particularly can include one or more polymers that can be effective to impart the desired effects in preventing, reducing, or minimizing breakage of fibers and/or release of microfibers arising from breakage of fibers in fabrics. Suitable polymers can include polymers that are effective as one or both of a softening agent or a conditioning agent for a fabric comprising synthetic fibers or other fibers that persist in the environment. As such, the polymer that is utilized in the present compositions can provide softening and/or conditioning of fabrics but also must be effective for preventing, reducing, or minimizing breakage of fibers and thus preventing, reducing, or minimizing release of microfibers from the fabrics, particularly during a laundering process. As a result, the present compositions can provide fabric preservation in relation to protecting the fibers from damage and therefore reducing environmental impact of microplastics but also can provide enhanced consumer feel to the fabrics to which the compositions may be applied.

Some polymers that are effective as a softening agent or a conditioning agent can be effective for protecting fibers so as to prevent, reduce, or minimize release of microfibers into the environment. Rather, the present disclosure has identified that a variety of factors must be met in order to identify a suitable softening/conditioning polymer that is also effective for protecting fibers as discussed herein. For example, polymer efficacy for protecting fabrics can rely at least in part on the ability of the conditioning/softening polymer to accumulate on the fibers present in the fabrics treated with the compositions. As such, a polymer useful for protecting fibers according to the present disclosure can be configured to adhere to, or otherwise bind to, at least a portion of the fibers of the fabric being treated. The ability of the polymer to bind to at least the fibers of the fabrics can relate to polymer charge density, the nature of the functional groups on the polymer, and thus the overall affinity of the polymer to the specific fibers used in the fabrics.

In one or more embodiments, the polymers and compositions of the present disclosure can be particularly effective in fabrics comprising, at least in part, synthetic fibers. The synthetic fibers may comprise a relatively small amount of the overall fibers of the fabric, such as the range of about 1% by weight to about 50% by weight, about 5% by weight to about 40% by weight, or about 10% by weight to about 35% by weight of the overall weight of the fabric. The synthetic fibers may comprise a significantly higher amount of the overall fibers of the fabric, such as the range of about 25% by weight to 100% by weight, about 35% by weight to about 95% by weight, or about 50% by weight to about 90% by weight of the overall weight of the fabric. In further embodiments, synthetic fibers may account for at least 10%, about 25%, at least 50%, at least 75%, or at least 90% by weight of the overall weight of the fabric, understanding that an upper range may include up to 100% by weight.

The present compositions are suitable for use with a wide variety of fiber types, including one or both of natural fibers and synthetic (i.e., man-made) fibers. Although the present disclosure may reference synthetic fibers in particular, it is understood that the disclosure is intended to encompass protection of any fiber that may be subject to breakage and that may result in particles or microfibers that will persist in the environment - e.g., taking longer than 1 month, longer than 6 months, longer than 12 months, or longer than 24 months to degrade. In some embodiments, the disclosure may be expressly limited to only synthetic fibers, may be limited to any fiber (synthetic or natural) that persists in the environment for a time as noted above, or may encompass any natural or synthetic fiber, and particularly those described herein. Natural fibers can encompass cellulose-based fibers, such as bamboo, flax, hemp, jute, ramie, manila, sisal, cotton, and kapok, protein-based fibers, such as alpaca, camel, cashmere, llama, mohair, vicuna, wool, and silk, and mineral-based fibers, such as asbestos. Synthetic fibers can be organic or inorganic in origin. Organic, synthetic fibers includes those based on natural polymers, such as Rayon, Lyocell, Acetate, triacetate, azlon, and polylactic acid (PLA) and those based on synthetic polymers, such as acrylic, anidex, aramid, elastoester, fluoropolymer, lastrile, melamine, modacrylic, novoloid, nylon, nytril, olefin, polybenzimidazole (PBI), polyester, rubber, saran, spandex, sulfar, vinal, and vinyon. The present compositions may be particularly suitable for use with fabrics comprising synthetic fibers selected from one or more of polyamide fibers, polyester fibers, polyether-polyurea fibers, and acrylonitrile fibers. This can include various grades of nylons, Lycra® or Spandex, and similar, synthetic fibers. The present compositions may be particularly suitable for use with fabrics comprising natural fibers when the natural fibers are those that are not readily biodegradable since the same desire for preventing or reducing release of non-biodegradable materials would similarly apply to natural fibers that are not readily biodegradable.

Breakage of fibers may arise at least in part from the application of mechanical forces (e.g., forces encountered in washing machines or in daily use of the fabrics, such as wearing, folding, stretching, and other handling or movements) to the fabrics. Friction and similar forces thus can break the fibers and lead to release of microfibers from the broken segments. Polymer fiber breakage may also arise at in part due to effects of temperature, pH (acids or bases), UV (sunlight), humidity, or other possible chemical reactions such as oxidation (e.g. effect of chlorine from water) depending on polymer functional groups and linkages. The application of a particular conditioning/softening polymer to a fabric through contact with a composition according to the present disclosure can result in binding of the polymer to at least the fibers of the fabric. As evident from the present disclosure, however, it is understood that the compositions are not limited to application to fabrics but also may be applied directly to fibers prior to use in forming a fabric or similar material. The presence of the polymer bound to the fibers can contribute to the prevention or reduction of microfiber release from the fibers and from the fabrics incorporating the fibers. For example, the conditioning/softening polymer can provide lubricity as a surface coating that reduces frictional forces between the fibers or between the fibers and exterior items. The polymer likewise can impart suppleness or increase suppleness of the fibers and thus reduce or inhibit tendency of the fibers to break. Still further, the presence of the polymer on the fiber surface can impart a smoothness to the fabric, or the fibers specifically, that can limit damaging effects of frictional forces.

Polymers that are useful according to the present disclosure likewise must be suitable for incorporation into the overall compositions. Since the chemical makeup of many synthetic fibers (and some natural fibers) imparts an effective negative charge to the fibers, polymers useful in the present compositions preferably are cationic and thus effective for binding to the synthetic fibers of the fabric due to at least charge interactions. On the other hand, polymers that have too great of a cationic charge density can be incompatible with other composition components. For example, laundry detergents can include a number of anionic ingredients, such as anionic surfactants. Polymers with an excessively high cationic charge density may have undesirable charge interactions with any anionic components of the compositions and thus be unavailable for binding to the synthetic fibers of the fabrics being treated. Additionally, conditioning/softening polymers with large molecular weights can have low solubility in the aqueous medium typically used in the present compositions. Charge density can be evaluated by any suitable method. For example, conductometric titration can be used, such as described by Farris et al., J. chem. Educ. 2012, 89, 1, 121-124 (published Oct. 18, 2011), the disclosure of which is incorporated herein by reference. Charge density can also be measured as the zeta potential, which is a measure of the magnitude of the electrostatic or charge repulsion/attraction between particles.

As further seen in the Examples appended hereto, it has been found that efficacy of a polymer as a conditioning/softening material does not necessarily correlate with efficacy for protecting fibers as required herein. Rather, testing showed that certain groups of polymers exhibited the necessary efficacy. As such, while the present disclosure favors the use of conditioning/softening polymers, usefulness as described herein requires that a particular polymer be shown effective for preventing, reducing, or minimizing breakage of fibers and likewise be suitable for incorporation into compositions as otherwise described herein. In particular, cellulose ether polymers were found to be particularly effective at preventing, reducing, or minimizing breakage of fibers and, likewise, preventing, reducing, or minimizing release of microfibers during washing. A non-limiting example of an effective cellulose ether polymer is the material sold under the tradename SUPRACARE™ 190. Further, non-limiting examples of polymers that are useful according to the present disclosure include: silicone modified proteins, such as copolymers of silicone with wheat proteins (e.g., the material sold under the tradename COLTIDE™ HSi) or with other, similar, proteins; pegylated ammonium chlorides (e.g., the material sold under the tradename MAQUAT® SL-5); and copolymers of acrylamides and allylic ammonium chlorides. During testing, as described below, such polymers were found to be compatible with presently disclosed laundry compositions and provided varying degrees of effectiveness at preventing or reducing microfiber release. In various embodiments, efficacy for protecting fibers is not necessarily limited to conditioning/softening polymers. Rather, polymers effective for providing similar effects as described herein can include those that are effective for adding or increasing lubricity. For example, anionic, sulfonic acid based polymers may be used, including but not limited to polyacrylamidomethylpropane sulfonic acid, such as the material sold under the tradename Rheocare® HSP1180 may be useful for protecting fibers as required herein.

In some embodiments, the polymer used in one or more compositions as described herein may be expressly chosen to selectively adhere to one or more specific type of synthetic fiber(s) or natural fiber(s). For example, the polymer may be configured to specifically bind to any one or more of polyamide fibers, polyester fibers, polyether-polyurea fibers, and/or acrylonitrile fibers.

In any of the compositions described herein, one or more of the polymers that are effective to provide the protecting effects for fibers as described herein may be included in specified amounts. Any individual polymer may be utilized in an amount of about 0.01% or greater, about 0.05% or greater, about 0.1% or greater, about 0.5% or greater, about 1% or greater, or about 1.5% or greater by weight, based on the total weight of the composition. Such amounts, in some embodiments, may include an upper limit of about 5%, about 7%, or about 10% by weight, based on the total weight of the composition. The foregoing ranges are inclusive of any combination of any of the lower range limit with any of the upper range limit. In embodiments where a plurality of polymers that provide the protecting effects described herein are utilized, the total amount of the plurality of polymers present in the composition may be about 0.1% to about 10%, about 0.5% to about 8%, about 1% to about 7%, or about 2% to about 6% by weight based on the total weight of the composition. A preferred range can be, for example, about 0.1% to about 5% by weight based on the total weight of the composition. In some embodiments, compositions may be expressly limited to the use of a single polymer or may expressly require at least two of the polymers.

In some embodiments, the compositions of the present disclosure can be provided particularly as a liquid composition. As such, the conditioning/softening polymer (as well as other components of the composition) can be dissolved, suspended, dispersed, or otherwise entrained in a suitable medium. An aqueous medium can be preferred since a wide variety of compositions for use with clothing and other fabrics are typically water-based formulations. An aqueous medium particularly can be water, such as deionized or purified water; however, other aqueous media (e.g., buffered solutions, etc.) may be utilized. While aqueous compositions are preferred due to the ease of use and the compatibility with typical laundering processes to which the fabrics may be subjected, compositions formed with a non-aqueous medium are also envisioned and may find particular use in manufacturing of fabrics, dry cleaning processes, and other areas where non-aqueous compositions may be preferred. In one or more embodiments, the laundry composition can include the aqueous medium in an amount of quantum satis based on the total weight of the laundry composition and the amounts of the further components included in the composition. In some embodiments, compositions according to the present disclosure may particularly comprise about 5% by weight or more, about 10% by weight or more, about 20% by weight or more, about 30% by weight or more, or about 40% by weight or more of the aqueous medium (e.g., up to a maximum of 90-95% by weight). In further embodiments, the compositions may comprise about 5% to about 90%, about 10% to about 80%, about 20% to about 70%, or about 30% to about 65% by weight of the total composition. It is understood, however, that alternative forms are encompassed herein and a solid composition (e.g., powder or particulate), for example, may include no water or substantially no water or other aqueous medium.

As described herein, the laundry composition can be provided in various forms. The present compositions can be provided in solid and/or liquid forms, may be provided substantially as a laundry detergent composition (e.g., liquids, gels, powders, granules, pellets, or flakes), may be provided in a bulk form or in a unit dosage form (e.g., forms known as a “pod” or “pods”), may be provided as a roll-on or wipe-on composition, may be provided as a spray-on, pump, foam, or aerosolized composition (e.g., a “refresher” composition, spot treatment, or the like), may be provided as sheets, tablets, strips, films, foils, swatches, or any other suitable form. The nature of the compositions likewise can provide for use in a wide variety of applications. For example, the present compositions may be configured for application in any one or more of the following: applied directly to fibers; applied directly to a fabric, such as during manufacturing of the fabric; applied during a dry cleaning processes; applied as a pretreatment to a fabric article prior to laundering; applied as a non-laundering treatment to a fabric article (e.g., a refresher or similar composition that is suitable for application to fabric articles separate from laundering); or applied to fabric articles in a typical laundering process (e.g., a detergent, softener, scent booster, or the like in a washing machine or as an additive for use in a drying machine).

In some embodiments, a composition according to the present disclosure particularly may be a laundry detergent composition. As such, the laundry composition can include, in addition to one or more conditioning/softening polymers, any one or more components suitable for use in a laundry detergent. For example, in some embodiments, the laundry detergent composition can comprise an aqueous medium (or other suitable medium, depending on the desired format and intended use), one or more surfactants, and one or more fiber-protecting polymers as described herein. Non-limiting examples of other ingredients that may be included in a laundry detergent according to the present disclosure include chelators, builders, alkalinizing agents, viscosifiers, bicarbonates, enzymes, enzyme stabilizers, dyes, optical brighteners, antiredeposition polymers, fluorescent whitening agents, fragrances, bittering agents, antifoaming agents, pH adjustors, bleaches, pearl luster agents, preservatives, laundry boosters, and combinations thereof. Any of the above components, as well as other components typically found in such products, can be utilized in any composition as described, irrespective of form or intended use. Further, any other component described herein that is not otherwise defined as being required may be optionally, expressly excluded from embodiments of a laundry detergent composition.

In certain embodiments, a laundry detergent composition according to the present disclosure that is effective for preventing or reducing release of microfibers can comprise one or more anionic or nonionic surfactants and a polymer that is effective as one or both of a softening agent or a conditioning agent for a fabric comprising fibers as described herein. In particular, the polymer can be configured to adhere to at least a portion of the fibers of the fabric when the fabric and the laundry composition are both present in a washing medium. Further, the polymer, when adhered to the fibers, can be effective to prevent or reduce formation of microfibers due to breakage of the fibers and thus prevent or reduce release of the microfibers into the washing medium.

The surfactant(s) used in a laundry detergent composition as described herein may be defined in relation to being a “surfactant system,” which is understood to refer to the all of surfactant(s) that are present in the composition. In some embodiments, the surfactant system may include one or more surfactants consisting of only anionic surfactants. In other embodiments, the surfactant system may include one or more surfactants consisting of only nonionic surfactants. In some embodiments the surfactant system may comprise both anionic and nonionic surfactants. When one or more anionic and nonionic surfactants are present, it can be preferable for the anionic or nonionic surfactants to be present in a total amount of up to about 70% by weight based on the total weight of the composition. In some embodiments, the surfactant can be present in a relatively lower concentration, such as about 1% to about 25%, about 3% to about 20% by weight, or about 5% to about 20% by weight based on the total weight of the laundry composition. In other embodiments, higher surfactant concentrations may be desired, such as in the range of about 10% to about 70%, about 30% to about 65%, or about 40% to about 60% by weight based on the total weight of the laundry composition.

Anionic surfactants suitable for use according to the present disclosure can include those that are configured for removal of soiling agents, such as dirt, clay, and/or oily materials. In some embodiments, the anionic surfactant may be configured for at least partial deposition onto surfaces of items being laundered to provide resistance to re-deposition of soiling agents onto the items during the laundering process. The anionic surfactant retained on the surfaces of the laundered items can be removed therefrom during the rinse cycle of the laundering process. According to the present disclosure, a wide variety of anionic surfactants may be used. In various embodiments, a suitable anionic surfactant may include one or more salts (e.g., sodium, potassium, ammonium, and substituted ammonium salts such as mono-, di- and triethanolamine salts) of anionic sulfates, sulfonates, carboxylates, and sarcosinates. Exemplary anionic sulfates can include linear and/or branched primary and secondary alkyl sulfates, alkyl ethoxysulfates, fatty oleoyl glycerol sulfates, alkyl phenol ethylene oxide ether sulfates, C₅—C₁₇ acyl—N—(C₁—C₄ alkyl) and —N—(C₁—C₂ hydroxyalkyl) glucamine sulfates, and sulfates of alkylpolysaccharides, such as alkylpolyglucoside sulfates. Exemplary alkyl sulfates can include linear and branched primary C₁₀—C₁₈ alkyl sulfates. Exemplary alkyl ethoxysulfate surfactants can include C₁₀—C₁₈ alkyl sulfates that have been ethoxylated with from 0.5 to 20 moles of ethylene oxide per molecule. Exemplary anionic sulfonate surfactants can include salts of C₅—C₂₀ linear alkylbenzene sulfonates, alkyl ester sulfonates, C₆—C₂₂ primary or secondary alkane sulfonates, C₆—C₂₄ olefin sulfonates, sulfonated polycarboxylic acids, alkyl glycerol sulfonates, fatty acyl glycerol sulfonates, fatty oleyl glycerol sulfonates, and any mixtures thereof. Exemplary anionic carboxylates can include alkyl ethoxy carboxylates, and alkyl polyethoxy polycarboxylates. In some embodiments, preferred anionic surfactants can include various sulfates (e.g., alkyl ether sulfates, such as laureth sulfate salts), alkyl ester sulfonates, and alkylbenzene sulfonate (e.g., C₅ to C₂₀ or C₁₀ to C₁₆). Non-limiting examples of anionic surfactants that may be used herein include sodium laureth sulfate (SLES), sodium lauryl sulfate (SLS), methyl ester sulfonate (MES), and sodium C₁₀-₁₆ alkylbenzene sulfonate (LAS). In certain embodiments, ethoxylated anionic surfactants may be utilized and may comprise a limited number of moles of ethylene oxide groups. For example, an alkyl ether sulfate anionic surfactant may comprise less than 5 moles, or less than 4 moles of ethylene oxide groups, such as 1 to 4 or 2 to 3 ethylene oxide groups. A single anionic surfactant may be utilized or a plurality of anionic surfactants (e.g., 2, 3, 4, or more) may be used.

Nonionic surfactants suitable for use according to the present disclosure likewise can include those that are configured for removal of soiling agent as described above, and particularly those that can improve removal of oily materials on the laundered items. A wide variety of nonionic surfactants may be used according to the present disclosure. In various embodiments, a suitable nonionic surfactant may include alkyl ethoxylate condensation products of aliphatic alcohols with from 1 to 25 moles of ethylene oxide wherein the alkyl chain of the aliphatic alcohol can either be straight or branched, primary or secondary, and generally contains from 6 to 22 carbon atoms. Further suitable nonionic surfactants can include water soluble ethoxylated C₆—C₁₈ fatty alcohols and C₆—C₁₈ mixed ethoxylated/propoxylated fatty alcohols. For example, the ethoxylated fatty alcohols can be C₁₀—C₁₈ ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates. In some embodiments, the nonionic surfactant can be defined in relation to the alcohol chain length and/or the number of ethoxylate groups present in the molecule. For example, the nonionic surfactant can comprise an alcohol ethoxylate formed from an alcohol with a carbon chain length of 3 to 20 carbon atoms, 5 to 20 carbon atoms, 7 to 19 carbon atoms, 9 to 18 carbon atoms, 10 to 17 carbon atoms, or 12 to 15 carbon atoms. As a further example, the nonionic surfactant can comprise an alcohol ethoxylate having 2 to 10, 4 to 9, or 6 to 8 moles of ethylene oxide per mole of alcohol. Non-limiting examples of nonionic surfactants that may be used herein include ethoxylated alcohols (AE) (C₁₂—₁₅ alcohols, in particular), such as those available under the tradename NEODOL® (specifically available as NEODOL® 25-7), lauryl or myristyl glucosides (APG), and polyoxyethylene alkylethers (2° AE). A single nonionic surfactant may be utilized or a plurality of nonionic surfactants (e.g., 2, 3, 4, or more) may be used.

As discussed above, it can be particularly useful for the polymer component of the laundry detergent compositions to be specifically compatible with the further components of the laundry composition, particularly the surfactants. A stable composition according to the present disclosure can be defined such that the laundry composition, as finally formulated, will not exhibit substantial changes in properties during storage of the laundry composition. Properties that preferably will be substantially unchanged during storage can include one or more composition clarity (i.e., a substantially clear composition will remain substantially clear during storage, as evidenced by a measure of clarity changing by less than 5%, preferably less than 3%, and more preferably less than 2% from a clarity evaluated immediately after formulating), viscosity (i.e., viscosity will remain within +/- 5%, preferably +/- 3%, and more preferably +/-2% of the viscosity immediately after formulating), and pH (i.e., pH will remain within +/- 5%, preferably +/- 3%, and more preferably +/- 2% of the pH immediately after formulating). Applicable storage conditions during which the properties will be substantially unchanged can include conditions near the freezing temperature of the composition (e.g., about -10° C. to about 5° C., depending upon the exact formulation and the solids content of a liquid composition) and/or at a substantially high temperature, such as around 60° C. In some embodiments, storage conditions can be in a temperature range of about -10° C. to about 60° C., about 0° C. to about 55° C., or about 5° C. to about 50° C. for a time of at least 30 days, at least 60 days, or at least 90 days. When a composition is formulated to exhibit a desired color, stability can similarly be evaluated in relation to a measure of color changing by less than 5%, preferably less than 3%, and more preferably less than 2% from a color evaluated immediately after formulating. Clarity and/or color of the composition can be made by visual determination and/or through use of quantitative equipment, such as through spectrophotometric, colorimetric, turbidimetric, or light scattering methods. For compositions where clarity or color is not determinative (e.g., compositions that are intentionally opacified or powdered products), stability can be evaluated on the basis of the product remaining substantially homogeneous and/or on the basis of no or substantially evidence of separation and/or on the basis of a substantially unchanged viscosity and/or pH, as noted above. Stability data related to the present compositions is exemplified in Example 5 as provided herein.

Efficacy of a composition as described herein for preventing or reducing formation of microfibers can be quantified in relation to a mass of microfibers that can be recovered from a washing medium used in washing fabric(s) that include fibers that are subject to breakage for formation of microparticles/microfibers and that has been treated (before and/or during) with the composition. In unprotected washing processes, microfibers can be released from the fabrics including fibers of one or more types into the washing medium, and this can include the water that is withdrawn from any washing cycle(s) as well as any rinsing cycle(s) in a washing machine. This effluent (i.e., the total washing and rinsing liquids) can be captured and filtered to specifically recover microfibers, which in turn can be weighed. In some embodiments, a total amount of microfibers released into a washing medium from a mass of fabric(s) comprising fibers during washing with a laundry composition according to the present disclosure that includes the polymers that are effective for preventing or reducing microfiber production and/or release can be specifically less than a total amount of microfibers released during washing of a comparable mass of same type of fabric(s). Efficacy of the present compositions can be indicated when the total mass of microfibers released during washing with the presently disclosed laundry composition comprising the polymer is at least 20% less than a total mass of microfibers released during washing with the laundry composition without the polymer. In further embodiments, the total mass of microfibers released can be at least 30%, at least 40%, at least 50%, or at least 60% less when using a laundry detergent as presently claimed that includes the polymer component.

The presence of the polymer component in the composition applied to the fabric can provide the desired efficacy in preventing or reducing breakage of fibers and/or preventing or reducing release of formed microfibers in a variety of manners. In one or more embodiments, when the polymer in the laundry composition adheres or otherwise binds to the fibers to be protected, the polymer is effective to prevent or reduce formation of microfibers due to breakage of the fibers arising from frictional forces on the fabric during washing of the fabric. In other embodiments, the polymer in the laundry composition is configured to sufficiently adhere to the at least a portion of the fibers of the fabric so that an amount of the polymer remains adhered to the at least a portion of the fibers after removal from the washing medium. As such, the compositions can provide the desired effect during the washing process but also provide an extended effect so that fiber breakage is prevented or reduced after laundering the fabric with the laundry detergent composition.

In one or more embodiments, the present disclosure further can provide methods for preventing or reducing release of microfibers to the environment. Such methods can comprise contacting fibers with a polymer as described herein that is effective for preventing or reducing breakage of the fibers. Thereafter, mechanical forces that would otherwise be expected to cause breakage of the fibers can be prevented from causing breakage of the treated fibers and/or release of microfibers arising from breakage of the fibers can be prevented or reduced. The polymer particularly can be provided in a composition as described herein.

The action whereby the fibers are contacted with the polymer (such as in a composition as described herein) can be carried out by a consumer, such as by washing a fabric including the fibers with a laundry detergent composition that includes the polymer or otherwise applying a composition including the polymer to the fabric (such as spraying or otherwise applying a liquid composition with the polymer onto the fabric). The action whereby the fibers are contacted with the polymer likewise can be carried out by a manufacturer. For example, manufacturers of fibers that are subject to breakage (and thus subject to protection as described herein) may apply the polymer to the fibers so that the fibers can be protected from breakage during processes whereby fabrics (e.g., clothing articles) are formed. Such protection likewise can be retained by the formed fabrics. Further, manufacturers of fabrics can apply the polymer to fabrics including fibers to be protected from breakage before and/or after formation of an article to impart protection to the fibers therein. Such application may be carried out with a bulk unit of the fabric prior to formation of the finished article and/or with a specific article (e.g., an article of clothing) after manufacturing of the article. Such application of the polymer as described herein can beneficially impart desired properties to the fabric (e.g., softness) while simultaneously providing the desired protection from breakage of the fibers.

In some embodiments, the present disclosure can provide methods for imparting to a fabric improved resistance to formation of microfibers. For example, such methods can comprise applying to a fabric comprising fibers to be protected, a composition that comprises a polymer that is effective as one or both of a softening agent or a conditioning agent for the fabric comprising the fibers. The polymer can particularly be present in a composition as described herein and/or may be provided in a liquid medium, such as to provide for ease of application to the fabric. The application of the polymer can be effective so that the polymer becomes adhered or otherwise bound to at least a portion of the fibers of the fabric. Additionally, the presence of the polymer adhered to at least a portion of the fibers of the fabric can be effective to prevent or reduce formation of microfibers due to breakage of the fibers due to application of frictional forces to the fabric. The polymer can be configured to sufficiently adhere to the at least a portion of the fibers of the fabric so that an amount of the polymer will remain adhered to the at least a portion of the fibers after the fabric is subjected to a first washing. Likewise, the polymer can be configured to selectively adhere to one or more of the specific types of fibers (and particularly synthetic fibers) already discussed herein. The improved resistance to formation of microfibers can be evaluated in relation to an amount of microfibers released from the fabric into a washing medium. In some embodiments, the improved resistance is measurable such that a total mass of microfibers released during a washing in an aqueous washing medium from the fabric comprising the fibers to be protected with the polymer adhered to the fibers is at least 20%, at least 30%, at least 40%, at least 50%, or at least 60% less than a total mass of microfibers released during a washing in an aqueous washing medium from the fabric comprising the fibers without the polymer adhered to the fibers.

As previously discussed herein, release of microfibers into the environment is strongly linked to washing of fabrics whereby microfibers arising from breakage of fibers (and particularly synthetic fibers) are released from the fabric into the washing medium and subsequently pass through typical filtering components into municipal water treatment facilities. As such, the present disclosure particularly can provide methods whereby such release into a washing medium is prevented or reduced. For example, methods according to the present disclosure can comprise washing a fabric that comprises fibers so that prior to or during the washing, the fabric is contacted with a composition that comprises a polymer that is effective as one or both of a softening agent or a conditioning agent for the fabric comprising the fibers. As discussed above, the polymer can be configured to adhere to at least a portion of the fibers of the fabric. Additionally, when the polymer adheres to the fibers, the polymer is effective to prevent or reduce formation of microfibers due to breakage of the fibers and thus prevent or reduce release of the microfibers to the environment through effluent from the washing.

In some embodiments, the composition comprising the polymer can be a laundry detergent as described above. As such, the methods particularly can comprise washing the fabric with the laundry detergent. Because laundry detergents are configured for rapid dispersement into a washing medium, the polymer component of the laundry detergent can rapidly disperse throughout the washing medium to contact the fabrics being washed and bind with or otherwise adhere to fibers (and particularly synthetic fibers) present in the fabrics being washed. Thus, inclusion of the polymer in the laundry detergent can impart protection to the fibers in the fabrics being washed even if there has been no previous application of the polymer to the fibers and/or the fabrics including the fibers. The presence of the polymer in the laundry detergent thus imparts protection to the fibers at least during the washing and rinsing of the fabrics in a washing machine. Beneficially, at least a portion of the polymer can remain adhered to at least a portion of the fibers so that protection continues during drying of the fabrics (e.g., in a drying machine) and even during subsequent wearing of the articles (e.g., in relation to clothing items). In some embodiments, a composition according to the present disclosure comprising a protective polymer may be configured as a dryer additive so that the polymer can be released into the dryer during a drying cycle so that the fibers in the fabrics are protected from breakage arising from the frictional forces arising from the movement within the dryer drum. In some embodiments of the present methods whereby release of microfibers is prevented or reduced in relation to a washing method, the present compositions can be provided in forms other than a laundry detergent. For example, in some embodiments the compositions comprising the polymer can be configured as a pre-treatment, and the method thus can comprise applying the pre-treatment to the fabric prior to washing the fabric. As such, the polymer can be adhered or otherwise bound to at least a portion of the fibers in the fabrics before the fabrics are laundered. In further embodiments, such pre-treatments may be further configured as a spray, an aerosol, a roll-on, or any further form that allows for application to fabrics.

The efficacy of the methods in preventing or reducing release of microfibers through a washing medium can again be identified through comparison to washing in the absence of the polymer. The present methods thus can be effective in that a total mass of microfibers released from the fabric comprising the fibers to be protected during the washing with the polymer adhered to the fibers is at least 20% less than a total mass of microfibers released from the fabric comprising the fibers during washing without the polymer adhered to the fibers. In further embodiments, the total mass of microfibers released can be at least 30%, at least 40%, at least 50%, or at least 60% less when the polymer component is in contact with the fibers during the washing. Such efficacy can be achieved when the polymer is introduced directly into the washing machine (e.g., in a laundry detergent) and/or when the polymer is applied to a fabric (or the fibers of the fabric) prior to washing.

As further shown in the examples appended hereto, testing has shown that when the presently disclosed compositions and methods incorporating a protective polymer are used, there is a reduction in the amount of microfibers released from the fabric into a washing medium compared to compositions and methods that do not incorporate the protective polymer. During testing to evaluate the ability to impart fibers with resistance of microfiber release, lab scale washing tests were performed on fabric swatches. As further described in the Examples below, not all polymers recognized as conditioning/softening polymers proved to be compatible with laundry detergents, and not all of the tested polymers provided the necessary efficacy for preventing or reducing release of microfibers into a washing medium. Testing did reveal the ability to identify specific polymers that were effective in reducing the mass of microfiber release from fabrics compared to not using the presently described laundry composition. As described above, the deposition of the conditioning/softening polymers on the fabric may result in smoother fabric surfaces and can likewise reduce fabric friction during experimental testing, leading to reduced microfibers, as shown by the incremental decrease in mass of microfibers with subsequent washings.

As can be seen from the foregoing, the compositions and methods described herein are effective for imparting fabrics having fibers as described herein with improved resistance to breakage of the fibers and thus can prevent or reduce release of microfibers to the environment. Because of such efficacy, the present disclosure also can provide articles that exhibit improved resistance to release of microfibers. In particular, the articles exhibit such properties due at least in part to the fibers included therein being protected from breakage arising from the presence of the polymer as discussed herein on the fiber.

In one or more embodiments, an article exhibiting improved resistance to release of microfibers can comprise a fabric that includes fibers as described herein and also can comprise a polymer that is adhered or otherwise bound to at least a portion of the fibers of the fabric. The polymer particularly can be effective as one or both of a softening agent or a conditioning agent for the fabric with the fibers. Additionally, the presence of the polymer adhered or otherwise bound to at least a portion of the fibers of the fabric can be effective to prevent or reduce formation of microfibers due to breakage of the fibers due to application of frictional forces to the fabric. Efficacy of the article in relation to having improved resistance to release of microfibers can be evaluated as otherwise described herein, such as by wash testing whereby articles with the applied polymer are compared with like articles that do not have the applied polymer to measure the mass of microfibers that are released into the washing medium.

In further embodiments, the article exhibiting improved resistance to release of microfibers can be fibers that are suitable for use in forming articles, such as clothing items and other fabrics. In particular, synthetic fibers, such as polyamide fibers, polyester fibers, polyether-polyurea fibers, acrylonitrile fibers, and the like can be specifically processed so that the fibers have a conditioning/softening polymer as described herein applied to a surface of the fibers or even incorporated into the fibers (e.g., through addition into a melt-spinning process). The fibers with the polymer adhered thereto and/or included therein can be provided as a product for use in formation of fabrics so that the fabrics exhibit resistance to microfiber formation.

### EXPERIMENTAL

Tests were carried out to evaluate compatibility of conditioning/softening polymers in liquid laundry detergent compositions according to the present disclosure. Such compositions including the polymers were also compared with the liquid laundry detergent without the polymers to evaluate efficacy in reducing release of microfibers during washing of a fabric including synthetic fibers.

### Example 1 - Phase Composition Study

A phase composition study was performed to determine compatibility of various conditioning/softening polymers with nonionic surfactants and anionic surfactants typically found in liquid laundry detergents. The following conditioning/softening polymers were tested: COLTIDE™ HSi (a copolymer of hydrolyzed wheat protein and silicone); MAQUAT® SL-5 (a dihydroxypropyl PEG-5 linoleammonium chloride); Dow SUPRACARE™ 190 (a cationic cellulose ether polymer); Antistat 7 (a cationic copolymer of acrylamide and diallyldimethylammonium chloride); and STEPANQUAT® Helia (a quaternary polymer).

To carry out the testing, a 1% (w/w) solution of each polymer was prepared along with a 10% (w/w) solution of an anionic surfactant, alkyl ether sulfate, and a 10% (w/w) solution of a nonionic surfactant, alcohol ethoxylate. Using pipettes, aliquots of the appropriate polymer solution and one or both of the anionic surfactant solution and the nonionic surfactant solution were transferred to individual test tubes according to the amounts shown in TABLE 1 below.

TABLE 1

| | Polymer and surfactant relative wt. ratios | | | Polymer and surfactant masses used | | |
|---|---|---|---|---|---|---|
| Test Tube | Wt% of 1% polymer solution | Wt% of 12% w/ w alcohol ethoxylate surfactant | Wt% of 12% w/ w alkyl ether sulfate surfactant | Mass (g) of 1% polymetr solution | mass (g) of 12% w/ w alcohol ethoxylate surfactant | Mass(g) of 12% w/ w alkyl ether sulfate surfactant |
| 1 | 80 | 20 | 0 | 1.6 | 0.4 | 0 |
| 2 | 60 | 40 | 0 | 1.2 | 0.8 | 0 |
| 3 | 40 | 60 | 0 | 0.8 | 1.2 | 0 |
| 4 | 20 | 80 | 0 | 0.4 | 1.6 | 0 |
| 5 | 90 | 0 | 10 | 1.8 | 0 | 0.2 |
| 6 | 80 | 10 | 10 | 1.6 | 0.2 | 0.2 |
| 7 | 70 | 20 | 10 | 1.4 | 0.4 | 0.2 |
| 8 | 50 | 40 | 10 | 1.0 | 0.8 | 0.2 |
| 9 | 30 | 60 | 10 | 0.6 | 1.2 | 0.2 |
| 10 | 10 | 80 | 10 | 0.2 | 1.6 | 0.2 |
| 11 | 0 | 90 | 10 | 0 | 1.8 | 0.2 |
| 12 | 80 | 0 | 20 | 1.6 | 0 | 0.4 |
| 13 | 60 | 20 | 20 | 1.2 | 0.4 | 0.4 |
| 14 | 40 | 40 | 20 | 0.8 | 0.8 | 0.4 |
| 15 | 20 | 60 | 20 | 0.4 | 1.2 | 0.4 |
| 16 | 0 | 80 | 20 | 0 | 1.6 | 0.4 |
| 17 | 70 | 0 | 30 | 1.4 | 0 | 0.6 |
| 18 | 60 | 10 | 30 | 1.2 | 0.2 | 0.6 |
| 19 | 50 | 20 | 30 | 1.0 | 0.4 | 0.6 |
| 20 | 35 | 35 | 30 | 0.7 | 0.7 | 0.6 |
| 21 | 20 | 50 | 30 | 0.4 | 1.0 | 0.6 |
| 22 | 10 | 60 | 30 | 0.2 | 1.2 | 0.6 |
| 23 | 0 | 70 | 30 | 0 | 1.4 | 0.6 |
| 24 | 60 | 0 | 40 | 1.2 | 0 | 0.8 |
| 25 | 50 | 10 | 40 | 1.0 | 0.2 | 0.8 |
| 26 | 30 | 30 | 40 | 0.6 | 0.6 | 0.8 |
| 27 | 10 | 50 | 40 | 0.2 | 1.0 | 0.8 |
| 28 | 0 | 60 | 40 | 0 | 1.2 | 0.8 |
| 29 | 50 | 0 | 50 | 1.0 | 0 | 1.0 |
| 30 | 40 | 10 | 50 | 0.8 | 0.2 | 1.0 |
| 31 | 25 | 25 | 50 | 0.5 | 0.5 | 1.0 |
| 32 | 10 | 40 | 50 | 0.2 | 0.8 | 1.0 |
| 33 | 0 | 50 | 50 | 0 | 1.0 | 1.0 |
| 34 | 30 | 10 | 60 | 0.6 | 0.2 | 1.2 |
| 35 | 20 | 20 | 60 | 0.4 | 0.4 | 1.2 |
| 36 | 10 | 30 | 60 | 0.2 | 0.6 | 1.2 |
| 37 | 30 | 0 | 70 | 0.6 | 0 | 1.4 |
| 38 | 15 | 15 | 70 | 0.3 | 0.3 | 1.4 |
| 39 | 0 | 30 | 70 | 0 | 0.6 | 1.4 |
| 40 | 20 | 0 | 80 | 0.4 | 0 | 1.6 |
| 41 | 10 | 10 | 80 | 0.2 | 0.2 | 1.6 |
| 42 | 0 | 20 | 80 | 0 | 0.4 | 1.6 |
| 43 | 10 | 0 | 90 | 0.2 | 0 | 1.8 |
| 44 | 0 | 10 | 90 | 0 | 0.2 | 1.8 |

After addition of the appropriate amounts of the solutions, each test tube was vortexed for complete mixing. The test tubes were then observed to identify occurrence of layer separation, formation of solid precipitates, or maintenance as a substantially clear liquid. Layer separation and/or formation of precipitates (e.g., cloudiness) indicated incompatibility of the polymer with the surfactant(s). The evaluations showed that both of the COLTIDE™ HSi and MAQUAT® SL-5 were compatible with the anionic and nonionic surfactants while the STEPANQUAT® Helia exhibited excessive cloudiness and was thus incompatible. Compositions made with SUPRACARE™ 190 and Antistat 7 likewise exhibited acceptable stability.

### Example 2 - Tergotometer Testing of Fabric Swatches

Testing to evaluate efficacy for preventing or reducing release of microfibers into a washing medium was carried out using a Copley Scientific Tergotometer (available from MSP Corp). Briefly, fabric swatches (untreated or treated with a composition as described herein) were processed through the tergotometer, and microfibers were captured from the washing medium to evaluate the mass of microfibers released into the washing medium from the swatches. Composition performance was measured as a function of the ability to reduce the mass of microfibers released during washing.

Test compositions were prepared by modifying a commercially available liquid laundry detergent to include 1% w/w of COLTIDE™ HSi polymer or 1% w/w of MAQUAT® SL-5 polymer. Laundry detergent without any polymer additive was used as a comparative. Fabric samples tested were prepared as swatches of the following fabric types: terry cotton towel; knitted cotton; woven cotton; polycotton; Dacron; nylon; and polyester/lycra. Swatches were also prepared from a used synthetic stretchpant garment made of 72% rayon, 24% nylon, and 4% spandex. Tergotometer conditions were set for washing at a temperature of 86° F. in 120 ppm hardness water for 12 minutes followed by a water rinse at ambient temperature for 6 minutes (120 ppm hardness). Washing water was prepared for first forming a 12,000 ppm hard water solution by dissolving 11.02 g CaCl₂·2H₂O and 5.08 g MgCl₂·6H₂O in 800 mL deionized water in a beaker using a stir bar and stir plate. The solution was then transferred quantitatively into a 1-L volumetric flask, and additional deionized water was used to fill to the 1-L mark followed by mixing.

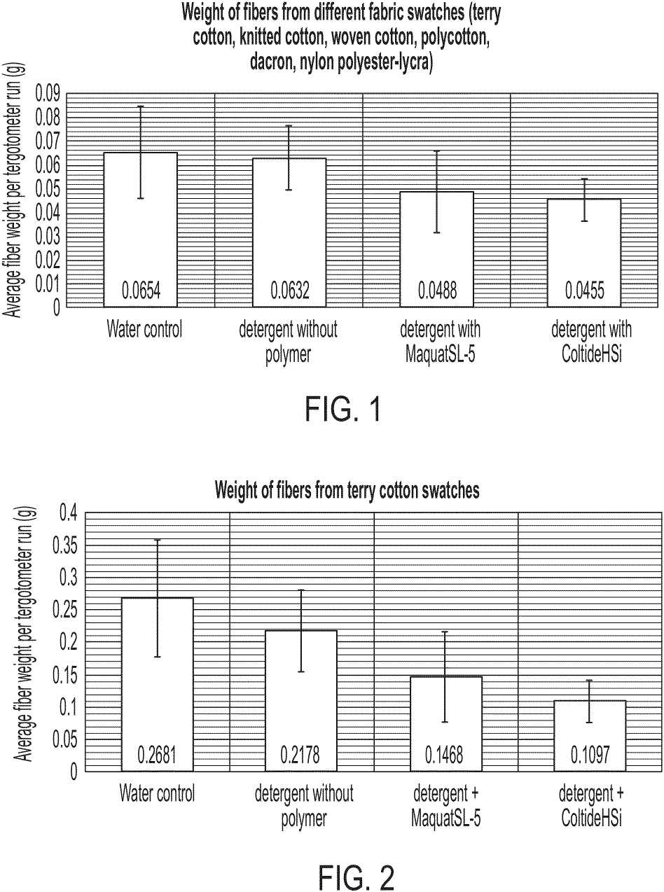

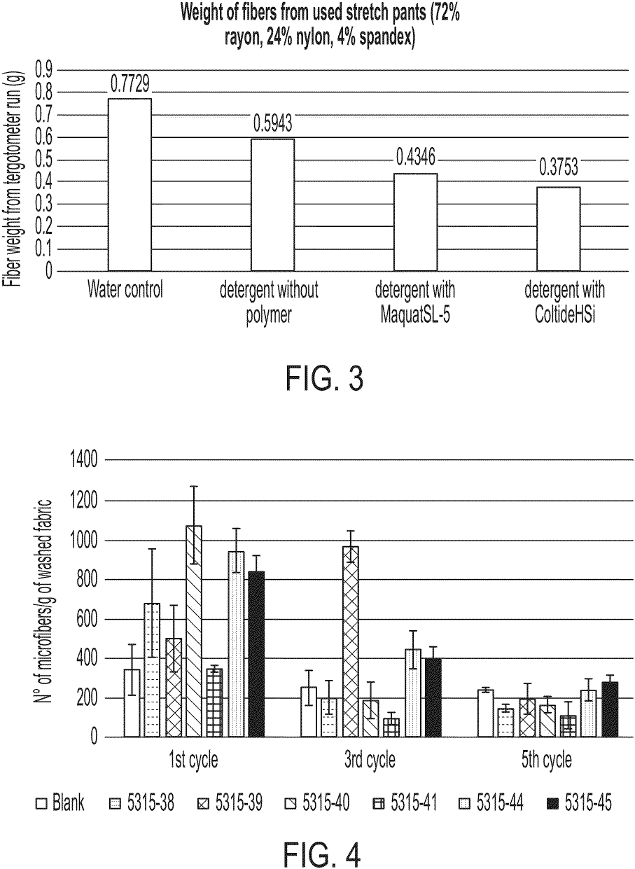

For each test in the tergotometer, wash water was prepared by adding 989.25 g of deionized water and 10 mL of the 12,000 ppm hard water to the tergotometer bucket. When the temperature of the wash water in the tergotometer bucket was at 86° F., the appropriate swatches were added to the bucket along with 0.75 g of the test product (laundry detergent alone or laundry detergent plus the polymer component). Testing was carried out using: (1) one swatch each of the seven fabric types noted above (7 swatches total per bucket); (2) terry cotton swatches alone; and (3) swatches of only the synthetic stretchpant garment. For each test, washing proceeded in the tergotometer for 12 minutes. Afterwards, fibers were filtered off using two filtration setups. In the first filtration setup (as referenced in relation to the test results shown in FIG. 1 and FIG. 2), the wash water from the tergotometer was poured into a beaker through a filter purchased from a retail store under the description Reusable Washing Machine Universal Float Filter Bag Laundry Ball Floating Pet Fur Catcher Filtering Hair Removal Device, and the wash water minus the fibers was discarded. In the second filtration setup (as referenced in relation to the test results shown in FIG. 3), a Buchner funnel was fitted with a Whatman 185 mm size 3 filter (pore size = 6 um) that was attached to suction filtration flask connected to a water aspirator as a vacuum source. The wash water minus the fibers was then discarded. Rinse water was then prepared in each tergotometer bucket by first adding 990 g of deionized water and then adding 10 mL of the 12,000 ppm hard water. The washed swatches were then added to the tergotometer, which was operated for 6 minutes. The fibers were then filtered off using one of the filtration setups described above, and the recovered rinse water was discarded. The total fibers collected from the wash water and the rinse water were air dried and then weighed.

Test results are shown in FIGS. 1 to 3. As seen in FIG. 1, the use of the laundry detergent/polymer compositions with the mix of 7 fabric types resulted in a reduced content of microfibers released into the washing and rinsing water compared to the use of the laundry detergent alone or washing in water alone. The COLTIDE™ HSi provided slightly better performance than the MAQUAT® SL-5 polymer. The trend was likewise seen in the testing of the terry cotton swatches (FIG. 2) and the synthetic stretchpant garment swatches. Without wishing to be bound by theory, it is believed that the COLTIDE™ HSi provided the better performance due to better adherence to the fabric fibers by the protein units and better smoothness of the fiber surfaces arising from the silicone component as compared to insufficient affinity of the quaternary functional groups of the MAQUAT® SL-5 polymer to the fiber surfaces.

### Example 3 - Woven Polyester Fabric Testing

Standard woven polyester fabrics (ISO 105-F02 adjacent polyester, 130 grams per square meter (gsm), +/- 5 gsm, from Testfabrics, Inc.) were used in washing tests using various test and comparative compositions. The fabric was made of fibers arranged in a woven structure with yarns made of staple fibers (double yarn warp with single yarn weft). Fabric samples were prepared for washing by cutting square samples of 9 x 9 cm² using a hot knife cutter to thermosseal the edges. The samples were prewashed in distilled water to remove loose fibers, impurities, and any other types of fibers.

The test composition was prepared by modifying two commercially available liquid laundry detergents. The commercial laundry detergents generally had the following compositions: 3-20% surfactants; 0-5% builder (e.g., sodium carbonate and/or sodium bicarbonate); 0-5% enzymes and enzyme stabilizers; 0-5% minor constituents (e.g., antiredeposition polymer, fragrance, preservative, defoamer, and fluorescent whitening agent); and remainder water, all percentages being on a weight/weight basis. Six test samples were used as shown in TABLE 2 below, with conditioning/softening polymer content being in the range of 0.1% to 5% by weight.

TABLE 2

| ID | Conditioning/Softening Polymer |
|---|---|
| 5315-38 | NA |
| 5315-39 | COLTIDE™ HSi |
| 5315-40 | MAQUAT® SL-5 |
| 5315-41 | SUPRACARE™ 190 |
| 5315-44 | NA |
| 5315-45 | Antistat 7 |

The washing tests were performed at lab scale using a standard washing laundering machine Gyrowash (James H. Heal & Co, UK). The prewashed samples were placed in the steel containers of the Gyrowash, along with 10 steel balls to provide enhanced mechanical action for microfiber production, and washed for 45 min at 40° C. using distilled water plus the dose of liquid detergent suggested by the manufacturer of the two commercial detergents used. The liquor ratio (liquor:specimen) was 150:1 vol/wt, corresponding to 150 mL of liquor, i.e. the solution composed by distilled water plus the dose of detergent, per gram of fabric. Blank tests were performed by washing the fabric samples with only distilled water. Each type of test was performed in triplicates. The washing water obtained from the wash tests was filtered by means of a peristaltic pump (Velp Scientifica flow rate 100 mL/min) connected with Tygon tubes, throughout polyvinylidene fluoride (PVDF) filters (Durapore®, Merck Millipore), with an average pore width of 5 µm and a diameter of 4.7 cm. Then, 400 mL of Milli-Q water at 70° C. were fluxed in the filtration system since such amount of water was found optimal to avoid an excess of detergent on the filter surface. The filters were stored in closed Petri dishes and dried at 105° C. for 30 min. Five subsequent washing cycles were performed for each of the tests, filtering and analyzing the washing water coming from the 1st, 3rd and 5th cycles. Between washing cycles, fabric samples were dried at air in a fume hood, protected between two sheets of filter paper.

In order to determine the amount of microplastics released during the washing tests, the filter surfaces were analyzed using a scanning electron microscope (SEM) Quanta 200 FEG (FEI, ThermoFisher Scientific Electron Microscopy Solutions, Netherlands). Quantitative evaluation of the amount of microfibers released by the tested fabrics during washing was performed using a counting method. For each filter sample, 21 electron micrographs were acquired along two orthogonal diameters of the circular filter with every micrograph representing a rectangular area (Ar) of the filter surface equal to 7.8 mm². The amount of microfibers (ni) in each micrograph was determined by visual observation with the help of the public domain software ImageJ (release 1.43 u). The number of fibers per unit area (Ci) for each i-image was calculated by the equation

$$\text{C} i = \text{n} i / \text{Ar}$$

where ni is the number of fibers of the i-image and Ar is the area of a single rectangle (7.8 mm²). The total number of fibers per filter (N) was determined by using the equation

$$\text{N =} \overline{C i} ⋅ A t o t$$

where C̅i̅ is the average number of fibers per unit area calculated as

$${\overline{C}}_{i} = \frac{\left({Σ}_{i = 1}^{21} {C}_{i}\right)}{21}$$

and where Atot is the total area of the filter (1709.4 mm²). Three filters were obtained by the three replicates of each washing test and underwent the described counting method to determine N per each filter, which as normalized to the weight of the washed fabric (in grams), obtaining the number of microfibers per gram of washed fabric. The average value of the number of microfibers per gram of washed fabric among the three filters was calculated along with the related standard deviation. Statistical analysis on the number of microfibers released per gram of washed fabric was carried out by using IBM SPSS® Statistics software.

The number of microfibers per gram of washed fabric released in the 1st, 3rd, and 5th washing cycles for the six test samples is shown in FIG. 4. As seen therein, there was variability in the effect of the polymers on microfiber release during the 1st, 3rd, and 5th washing cycles, particularly for the COLTIDE™ HSi polymer and the MAQUAT® SL-5 polymer. Through the 1st, 3rd and 5th wash cycles, however, the lowest number of released microfibers was seen using the SUPRACARE™ 190 polymer.

### Example 4 - Woven Polyester Fabric Testing

Polyester fabrics having a weight basis of 156 gsm were used in washing tests using various test and comparative compositions. Fabric samples were prepared to have a surface area 0.68 m² (+/- 0.08 m²) and weight of 105 grams (+/- 10 grams). Sample edges were sewn with a sewing machine applying stitch type 201, as described in ISO 4915:1991 and seam the edges as described in ISO 40513:1684, seam type 3.03.04. The samples were prewashed in distilled water to remove loose fibers, impurities, and any other types of fibers.

The test composition was prepared by modifying two commercially available liquid laundry detergents. The commercial laundry detergents generally had the following compositions: 3-20% surfactants; 0-5% builder (e.g., sodium carbonate and/or sodium bicarbonate); 0-5% enzymes and enzyme stabilizers; 0-5% minor constituents (e.g., antiredeposition polymer, fragrance, preservative, defoamer, and fluorescent whitening agent); and remainder water, all percentages being on a weight/weight basis. Six test samples were used as shown in TABLE 3 below, with conditioning/softening polymer content being in the range of 0.1% to 5% by weight.

TABLE 3

| ID | Conditioning/Softening Polymer |
|---|---|
| 5409-60 | SUPRACARE™ 190 |
| 5409-61 | NA |
| 5409-62 | Antistat 7 |
| 5409-63 | NA |
| 5409-64 | COLTIDE™ HSi |
| 5409-65 | NA |

Both size and weight of the tested sample was registered before starting the test to correlate the amount of microplastics shed after performing the test: per kg of fabric (mg/kg) and/or per surface unit of fabric (mg/m²). Each sample underwent a total of 5 simulated washing cycles, changing water in each cycle. The measurement of microplastics shed from the samples was obtained from the 1st, 3rd, and 5th simulated washing cycles. The washing simulation was performed in a metallic container free of oils on its surface. Extra weight was added to the washing container (to simulate the normal load that can be found in a domestic washing and to simulate aging of the sample) along with distilled water (R/B = 1/20), the test sample, and 6 grams of the detergent to be used. Various sized filters were used to filter the washing liquor collected from each simulated washing cycle in order to classify the amount of microparticles shed in different sizes. Filter pore sizes used were: 500 µm, 250 µm, 100 µm, 50 µm, 5 µm, and 0.45 µm.

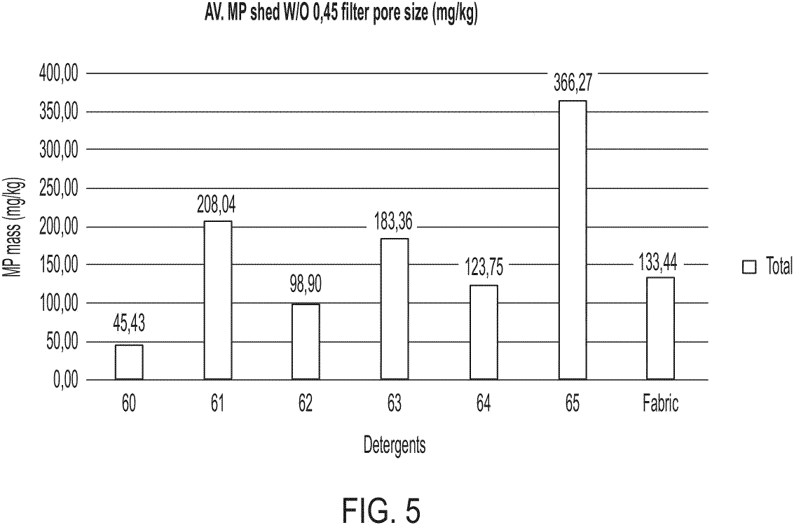

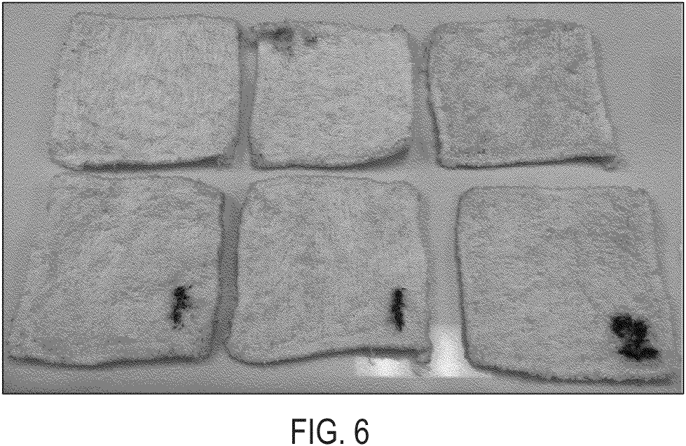

The mass of microfibers per kg of washed fabric released in the washing of the test samples is shown in FIG. 5. Release was calculated based on the number of microparticles captured on the 0.45 µm pore size filter. As seen in FIG. 5, the detergents with softening/conditioning polymers showed a lower mass of shed microparticles that included synthetic microfibers compared to the same detergents without the polymers. The detergent sample including the SUPRACARE™ 190 polymer showed the greatest reduction in released microparticles that included synthetic microfibers compared to the use of the same detergent without the polymer additive. Without wishing to be bound by theory, it is believed that the SUPRACARE™ 190 polymer exhibited the greatest affinity for binding to the surfaces of the synthetic fibers, thereby providing the greatest efficacy in reducing friction during lab-scale laundry washing, and consequently reducing microfiber release.

### Example 5 - Laundry Composition Stability Testing

A liquid laundry detergent composition modified to include a polymer component according to the present disclosure. The polymer was chosen to be a polymer that is: effective as one or both of a softening agent or a conditioning agent for a fabric comprising synthetic fibers; adheres to at least a portion of at least the synthetic fibers of the fabric when the fabric and the laundry composition are both present in a washing medium; and when adhered to at least the synthetic fibers, is effective to prevent or reduce formation of microfibers due to breakage of the synthetic fibers and thus prevent or reduce release of the microfibers into the washing medium. For the present testing, the polymer sold under the name Antistat 7 was added to the liquid laundry composition in an amount as otherwise described herein as being useful to achieve the desired results.

The modified laundry detergent composition was tested for stability under three separate sets of conditions. First, the composition was subjected to three cycles of freezing and thawing. Second, the composition was subjected to seven cycles of heating to 60° C. and returning to room temperature. Third, samples of the composition were separately stored for three months at 4° C., room temperature, 37° C., and 50° C. The stored samples were examined at 2 weeks, 4 weeks, 8 weeks, and 12 weeks to evaluate changes in appearance, clarity, and color.

All samples, upon evaluation, were deemed to pass each of the tests conducted - i.e., appearance, clarity, and color were deemed to be acceptable by the testing conditions encountered. Samples that were stored at 37° C. were again evaluated for viscosity and pH after one month of stability, and such samples were again found to be stable compared to the initial results.

### Example 6 - Deposition Testing

The ability of a polymer as described herein to provide the desired functionalities (e.g., adhere to fibers in a fabric and thus provide efficacy to prevent or reduce formation of microfibers due to breakage of the fibers during washing) was evaluated by anionic dye testing. The testing procedure is set forth below.

For each test, 1000 ml of deionized water was added to stainless steel containers, and the water within each container was heated to approximately 30° C. While heating, the detergent was weighed to provide the desired dosage. When the test temperature was reached, two swatches (100% cotton measuring 4.5 inches by 3 inches), were added to each container. Additionally, hardness stock solution (formed of calcium chloride dihydrate, magnesium chloride hexahydrate, and DI water) was added to each container to achieve 120 ppm hardness followed by adding the test detergent to each container. For each test, washing proceeded in the tergotometer for 12 minutes, after which, the tergotometer was turned off and the swatches were removed from each container. Each container was then emptied and rinsed with deionized water. The containers were then filled with 1000 ml of deionized water. Hardness solution was then added to each container in an amount to achieve 120 ppm hardness followed by adding the swatches back to their respective container. The tergotometer was run for 5 minutes without adjusting the temperature of the rinse water. Each swatch was removed after 5 minutes and placed them in a dryer on high for 45 minutes.

The next phase of testing included using Bromophenol Blue (BPB), an anionic dye, to treat each swatch. The anionic charge on the BPB allows it to bind to the cationic portions of the polymer. For each test, 0.025% (w/w) solution of BPB in water were prepared for each test article. Each test article, which included 2 swatches per test detergent was soaked in the 0.025% (w/w) solution of BPB for 20 minutes. After 20 minutes, the swatches were then removed and rinsed with copious amounts of tap water and allowed to air dry. Once the swatches were dry, each swatch was evaluated for visual differences in blue color.

Testing showed that the amount of the anionic dye remaining on the swatches increased based on the number of cycles of washing with the laundry detergent formulation including the polymer component as described herein. Specifically, the swatches washed with the composition including the polymer were visually darker in color due to a greater amount of the dye remaining on the swatches. This illustrated that the polymer component from the laundry detergent composition was deposited on the fibers of the washed fabric and that deposition of the polymer was cumulative, as indicated by the darker color provided by a greater amount of dye remaining bound to the polymer adhered to the fibers of the swatches washed with the laundry detergent composition including the polymer. Swatches that retained more anionic dye signified more polymer present.

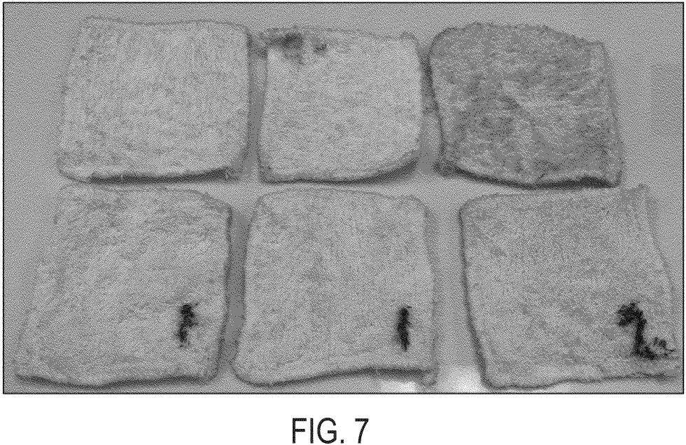

Results of the testing are shown in FIG. 6 (comparing results of washing with two commercial laundry detergents and washing with an inventive laundry composition including the polymer Antistat 7) and FIG. 7 (comparing results of washing with two commercial laundry detergents and washing with an inventive laundry composition including the polymer Supracare™ 190). In both figures, the bottom row shows color remaining on the swatches after a single washing cycle, and the top row shows color remaining on the swatches after 4 washing cycles. Also, in both figures, the left column and center column shows the swatches washed with the commercial laundry detergents, and the right column shows the swatches washed with the inventive compositions. It is evident in each of FIG. 6 and FIG. 7 that the washing with the composition including the polymer component resulted in a significantly greater amount of dye remaining on the swatch, particularly after four washing cycles.

The terms “about” or “substantially” as used herein can indicate that certain recited values or conditions are intended to be read as encompassing the expressly recited value or condition and also values that are relatively close thereto or conditions that are recognized as being relatively close thereto. For example, unless otherwise indicated herein, a value of “about” a certain number or “substantially” a certain value can indicate the specific number or value as well as numbers or values that vary therefrom (+ or -) by 5% or less, 4% or less, 3% or less, 2% or less, or 1% or less. Similarly, unless otherwise indicated herein, a condition that substantially exists can indicate the condition is met exactly as described or claimed or is within typical manufacturing tolerances or would appear to meet the required condition upon casual observation even if not perfectly meeting the required condition. In some embodiments, the values or conditions may be defined as being express and, as such, the term “about” or “substantially” (and thus the noted variances) may be excluded from the express value.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation

What is claimed is:

1. A laundry composition for preventing or reducing release of microfibers, the laundry composition comprising:
one or more anionic or nonionic surfactants; and
a polymer that is effective as one or both of a softening agent or a conditioning agent for a fabric comprising fibers, wherein the polymer is configured to adhere to at least a portion of at least the fibers of the fabric when the fabric and the laundry composition are both present in a washing medium, and wherein the polymer, when adhered to at least the fibers, is effective to prevent or reduce formation of microfibers due to breakage of the fibers and thus prevent or reduce release of the microfibers into the washing medium.

2. The laundry composition of claim 1, wherein the laundry composition comprises a total amount of up to about 70% by weight of the one or more anionic or nonionic surfactants based on a total weight of the laundry composition.

3. The laundry composition of claim 1, wherein the laundry composition comprises up to about 5% by weight of the polymer relative to a total weight of the laundry composition.

4. The laundry composition of claim 1, wherein the polymer is compatible with all further components of the laundry composition such that the laundry composition as finally formulated is stable such that one or more measurable properties of the laundry composition as originally formulated remains substantially unchanged during storage of the laundry composition.

5. The laundry composition of claim 1, wherein the laundry composition is effective to prevent or reduce formation of microfibers such that a total mass of microfibers released into the washing medium from the fabric comprising the fibers during washing with the laundry composition comprising the polymer is at least 20% less than a total mass of microfibers released into the washing medium from the fabric comprising the fibers during washing with the laundry composition without the polymer.

6. The laundry composition of claim 1, wherein the polymer, when adhered to at least the fibers, is effective to prevent or reduce formation of microfibers due to breakage of the fibers arising from frictional forces on the fabric during washing of the fabric.

7. The laundry composition of claim 1, wherein the polymer is selected from the group consisting of a silicone modified protein, a pegylated ammonium chloride, a cellulose ether polymer,a copolymer of an acrylamide and an allylic ammonium chloride, and combinations thereof.

8. The laundry composition of claim 1, wherein one or both of the following conditions is met:
the polymer is configured to sufficiently adhere to the at least a portion of the fibers of the fabric so that an amount of the polymer remains adhered to the at least a portion of the fibers after removal from the washing medium;
the polymer is configured to selectively adhere to one or more of polyamide fibers, polyester fibers, polyether-polyurea fibers, and acrylonitrile fibers.

9. The laundry composition of claim 1, further comprising a component selected from the group consisting of chelators, builders, alkalinizing agents, viscosifiers, bicarbonates, enzymes, enzyme stabilizers, dyes, optical brighteners, antiredeposition polymers, fluorescent whitening agents, fragrances, bittering agents, antifoaming agents, pH adjustors, bleaches, pearl luster agents, preservatives, laundry boosters, and combinations thereof.

10. The laundry composition of claim 1, wherein the composition comprises about 30% by weight or more of an aqueous base, relative to a total weight of the laundry composition.

11. The laundry composition of claim 1, wherein the fibers are synthetic fibers.

12. A method for preventing or reducing release of microfibers to the environment, the method comprising:
washing a fabric that comprises fibers so that prior to or during the washing, the fabric is contacted with a composition that comprises a polymer that is effective as one or both of a softening agent or a conditioning agent for the fabric comprising the fibers, wherein the polymer is configured to adhere to at least a portion of the fibers of the fabric, and wherein the polymer, when adhered to least the fibers, is effective to prevent or reduce formation of microfibers due to breakage of the fibers and thus prevent or reduce release of the microfibers to the environment through effluent from the washing.

13. The method of claim 12, wherein the composition comprising the polymer is a laundry detergent, and the method comprises washing the fabric with the laundry detergent, or wherein the composition comprising the polymer is a pre-treatment, and the method comprises applying the pre-treatment to the fabric prior to washing the fabric, the pre-treatment optionally being configured as a spray, an aerosol, a foam, or a roll-on.

14. The method of claim 12, wherein a total mass of microfibers released from the fabric comprising the fibers during the washing with the polymer adhered to the fibers is at least 20% less than a total mass of microfibers released from the fabric comprising the fibers during washing without the polymer adhered to the fibers.

15. The method of claim 12, wherein the polymer, when adhered to the fibers, is effective to prevent or reduce formation of microfibers due to breakage of the fibers arising from frictional forces on the fabric during the washing.

16. The method of claim 12, wherein the polymer is selected from the group consisting of a silicone modified protein, a pegylated ammonium chloride, a cellulose ether polymer, a copolymer of an acrylamide and an allylic ammonium chloride, and combinations thereof.

17. The method of claim 12, wherein one or both of the following conditions is met:
the polymer is configured to sufficiently adhere to the at least a portion of the fibers of the fabric so that an amount of the polymer remains adhered to the at least a portion of the fibers after the washing;
the polymer is configured to selectively adhere to one or more of polyamide fibers, polyester fibers, polyether-polyurea fibers, and acrylonitrile fibers.

18. The method of claim 12, wherein the fibers are synthetic fibers.

19. An article exhibiting improved resistance to release of microfibers, the article comprising:
a fabric that comprises fibers; and
a polymer that is adhered to at least a portion of the fibers of the fabric, the polymer being effective as one or both of a softening agent or a conditioning agent for the fabric comprising the fibers;
wherein the presence of the polymer adhered to at least a portion of the fibers of the fabric is effective to prevent or reduce formation of microfibers due to breakage of the fibers due to application of frictional forces to the fabric.

20. The article of claim 19, wherein one or more of the following conditions is met:
the polymer is selected from the group consisting of a silicone modified protein, a pegylated ammonium chloride, a cellulose ether polymer, a copolymer of an acrylamide and an allylic ammonium chloride, and combinations thereof;
the polymer is configured to sufficiently adhere to the at least a portion of the fibers of the fabric so that an amount of the polymer remains adhered to the at least a portion of the fibers after the article is subjected to a first washing;
the polymer is configured to selectively adhere to one or more of polyamide fibers, polyester fibers, polyether-polyurea fibers, and acrylonitrile fibers;
the article exhibits improved resistance to release of microfibers such that a total mass of microfibers released during a washing in an aqueous washing medium from the fabric comprising the fibers with the polymer adhered to the fibers is at least 20% less than a total mass of microfibers released during a washing in an aqueous washing medium from the fabric comprising the fibers without the polymer adhered to the fibers;
the fibers are synthetic fibers.

21. A method for imparting to a fabric improved resistance to formation of microfibers, the method comprising;
applying to a fabric comprising fibers a composition that comprises a liquid medium and a polymer that is effective as one or both of a softening agent or a conditioning agent for the fabric comprising the fibers, said applying being effective so that the polymer becomes adhered to at least a portion of the fibers of the fabric;
wherein the presence of the polymer adhered to at least a portion of the fibers of the fabric is effective to prevent or reduce formation of microfibers due to breakage of the fibers due to application of frictional forces to the fabric.

22. The method of claim 21, wherein one or more of the following conditions is met:
the polymer is selected from the group consisting of a silicone modified protein, a pegylated ammonium chloride, a cellulose ether polymer, a copolymer of an acrylamide and an allylic ammonium chloride, and combinations thereof;
the polymer is configured to sufficiently adhere to the at least a portion of the fibers of the fabric so that an amount of the polymer remains adhered to the at least a portion of the fibers after the fabric is subjected to a first washing;
the polymer is configured to selectively adhere to one or more of polyamide fibers, polyester fibers, polyether-polyurea fibers, and acrylonitrile fibers;
the fabric exhibits improved resistance to formation of microfibers such that a total mass of microfibers released during a washing in an aqueous washing medium from the fabric comprising the fibers with the polymer adhered to the fibers is at least 20% less than a total mass of microfibers released during a washing in an aqueous washing medium from the fabric comprising the fibers without the polymer adhered to the fibers;
the fibers are synthetic fibers.
